(19) United States
(12) Patent Application Publication
(10) Pub. No.: US 2021/0108101 A1
(43) Pub. Date: Apr. 15, 2021

(54) FLUORINATED POLYMER COATING COMPOSITIONS AND ARTICLES THEREFROM

(71) Applicant: 3M INNOVATIVE PROPERTIES COMPANY, St. Paul, MN (US)

(72) Inventors: Naiyong Jing, St. Paul, MN (US); Tho Q. Nguyen, Bloomington, MN (US); Gang Qian, Woodbury, MN (US)

(21) Appl. No.: 17/043,003

(22) PCT Filed: Jun. 10, 2019
(86) PCT No.: PCT/IB2019/054820

§ 371 Date: Sep. 29, 2020

Related U.S. Application Data
(60) Provisional application No. 62/683,652, filed on Jun. 12, 2018.

(51) Int. Cl. C09D 127/12; C09D 153/00; B05D 3/02; B05D 7/14

(52) U.S. Cl. CPC C09D 127/12; C09D 153/00; C08K 5/5465; B05D 7/14; B05D 3/0254

(57) ABSTRACT

Described herein is coating composition comprising (a) a partially fluorinated polymer, wherein the fluorinated polymer comprises a C—F bond adjacent to a methylene (—CH₂—) unit or a hydrohalogenated methylene (—CHX— where X is F, Cl, Br, or I) unit along the polymer backbone; (b) a protected amino silane; (c) an alkoxysilane; and (d) a non-fluorinated solvent. Also described herein are substrates coated with said coating composition and heated to bond the coating composition to the substrate.

### TECHNICAL FIELD

Coating compositions comprising a partially fluorinated polymer, a protected amino silane, an alkoxysilane, and a non-fluorinated solvent are discussed along with the coating compositions bonded to substrates.

### SUMMARY

There is a desire to identify fluoropolymer coating compositions that have substantial pot life and/or upon curing or heating, good adhesion to substrates especially when challenged with boiling water.

In one aspect, a coating composition is provided. The coating composition comprising
(a) a partially fluorinated polymer, wherein the fluorinated polymer comprises a C—F bond adjacent to a methylene (—CH₂—) unit or a hydrohalogenated methylene (—CHX— where X is F, Cl, Br, or 1) unit along the polymer backbone;
(b) a protected amino silane;
(c) an alkoxysilane; and
(d) a non-fluorinated solvent.

In one embodiment, the protected amino silane comprises at least one of:

(R³O)₃—Si-L-N═C(R¹)₂ (I); and

(R³O)₃—Si-L-NH—C(≡O)OR² (II)

wherein each R¹ is independently selected from a linear or branched alkyl group comprising 1 to 6 carbon atoms, R² is selected from H, and a linear or branched alkyl group comprising 1 to 4 carbon atoms, each R³ is independently an alkyl group comprising one or two carbon atoms, and L is a divalent aliphatic, an aromatic hydrocarbon group, or a combination thereof.

In another aspect, a method of making a coated article is provided. The method comprising coating a substrate with a coating composition comprising (a) a partially fluorinated polymer, wherein the fluorinated polymer comprises a C—F bond adjacent to a methylene (—CH₂—) unit or a hydrohalogenated methylene (—CHX— where X is F, Cl, Br, or I) unit along the polymer backbone;

(b) a protected amino silane;

(c) an alkoxysilane; and

(d) a non-fluorinated solvent.

In yet another aspect, an article is provided comprising an inorganic substrate and a fluoropolymer composition bonded thereto, the fluoropolymer composition comprising (a) a partially fluorinated polymer, wherein the fluorinated polymer comprises a C—F bond adjacent to a methylene (—CH₂—) unit or a hydrohalogenated methylene (—CHX— where X is F, Cl, Br, or I) unit along the polymer backbone;

(b) a protected amino silane;

(c) an alkoxysilane; and

(d) a non-fluorinated solvent.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B);

“backbone” refers to the main continuous chain of the polymer;

“crosslinking” refers to connecting two pre-formed polymer chains using chemical bonds or chemical groups;

“cure site” refers to functional groups, which may participate in crosslinking;

“interpolymerized” refers to monomers that are polymerized together to form a polymer backbone;

“monomer” is a molecule which can undergo polymerization which then form part of the essential structure of a polymer;

“perfluorinated” means a group or a compound derived from a hydrocarbon wherein all carbon-hydrogen bonds have been replaced by carbon-fluorine bonds. A perfluorinated compound may however still contain other atoms bonded to carbon besides fluorine atoms, like oxygen atoms, chlorine atoms, bromine atoms and iodine atoms; and

“polymer” refers to a macrostructure having a number average molecular weight (Mn) of at least 50,000 dalton, at least 100,000 dalton, at least 300,000 dalton, at least 500,000 dalton, at least, 750,000 dalton, at least 1,000,000 dalton, or even at least 1,500,000 dalton and not such a high molecular weight as to cause premature gelling of the polymer.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

As used herein, “comprises at least one of” A, B, and C refers to element A by itself, element B by itself, element C by itself, A and B, A and C, B and C, and a combination of all three.

The compositions disclosed herein comprise fluoropolymer dispersed in a solvent, with a protected amino silane, and an alkoxysilane.

Fluoropolymer

The fluoropolymer of the present disclosure is a partially fluorinated polymer comprising a C—F bond adjacent to a methylene (—CH₂—) unit or a hydrohalogenated methylene (—CHX— where X is F, Cl, Br, or I) unit along the polymer backbone. For example, a polymer comprising —CF₂—CH₂—, —CF(CF₃)—CHF—, —CF(CF₃)—CH₂—, or —CHF—CH₂— units along the polymer backbone. Such polymers can be derived from vinyl fluoride (VF), vinylidene fluoride (VDF), and/or a polymerization of a fluorinated monomer with a nonfluorinated monomer.

Examples of fluorinated monomers used to derived the fluoropolymer of the present disclosure can include fluorinated C₂-C₈ olefins that may have hydrogen and/or chlorine atoms such as tetrafluoroethylene (TFE), chlorotrifluoroethylene (CTFE), 2-chloropentafluoropropene, dichlorodifluoroethylene, and fluorinated alkyl vinyl monomers such as hexafluoropropylene (HFP); fluorinated vinyl ethers, including perfluorinated vinyl ethers (PVE) and fluorinated allyl ethers including perfluorinated allyl ethers. Suitable non-fluorinated comonomers that can be used to derive the partially fluorinated polymer disclosed herein include vinyl chloride, vinylidene chloride and C₂-C₈ olefins such as ethylene (E) and propylene (P).

Examples of perfluorinated vinyl ethers that can be used in the disclosure include those that correspond to the formula:

CF₂═CFO(R_{f′}O)ₘR_{f} (III)

where R_{f′} is a linear or branched perfluoroalkylene radical groups comprising 2, 3, 4, 5, or 6 carbon atoms, m is an integer selected from 0, 1, 2, 3, 4, 5, 6, 7, 8, 9, and 10, and R_{f} is a perfluoroalkyl group comprising 1, 2, 3, 4, 5, or 6 carbon atoms. Exemplary perfluorovinyl ether monomers include: perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), perfluoro-3-methoxy-n-propylvinyl ether, perfluoro-2-methoxy-ethylvinyl ether, perfluoro-methoxy-methylvinylether (CF₃—O—CF₂—O—CF═CF₂), and CF₃—(CF₂)₂—O—CF(CF₃)—CF₂—O—CF(CF₃)—CF₂—O—CF═CF₂, and combinations thereof.

Examples of perfluorinated allyl ethers that can be used in the disclosure include those that correspond to the formula

CF₂═CFCF₂O(R_{f″}O)ₙ(R_{f′}O)ₘR_{f} (IV)

where R_{f″} and R_{f′} are independently linear or branched perfluoroalkylene radical groups comprising 2, 3, 4, 5, or 6 carbon atoms, m and n are independently an integer selected from 0, 1, 2, 3, 4, 5, 6, 7, 8, 9, and 10, and R_{f} is a perfluoroalkyl group comprising 1, 2, 3, 4, 5, or 6 carbon atoms. Exemplary perfluoroallyl ether monomers include: perfluoro (ethyl allyl) ether, perfluoro (n-propyl allyl) ether, perfluoro-2-propoxypropyl allyl ether, perfluoro-3-methoxy-n-propylallyl ether, perfluoro-2-methoxy-ethyl allyl ether, perfluoro-methoxy-methyl allyl ether, and CF₃—(CF₂)₂—O—CF(CF₃)—CF₂—O—CF(CF₃)—CF₂—O—CF₂CF═CF₂, and combinations thereof.

In one embodiment, the fluoropolymer comprises interpolymerized units derived at least 10, 15, 20, 25, 30 or even 35 wt % VDF; and at most 50, 60, or even 65 wt % VDF.

In one embodiment, the fluoropolymer comprises interpolymerized units derived at least 10, 15, 20, 25, 30 or even 35 wt % VF; and at most 50, 60, or even 65 wt % VF.

In one embodiment, the partially fluorinated polymer is a random copolymer, which is amorphous, meaning that there is an absence of long-range order (i.e., in long-range order the arrangement and orientation of the macromolecules beyond their nearest neighbors is understood). An amorphous polymer has no detectable crystalline character by DSC (differential scanning calorimetry), meaning that if studied under DSC, the polymer would have no melting point or melt transitions with an enthalpy more than 0.002, 0.01, 0.1, or even 1 Joule/g from the second heat of a heat/cool/heat cycle, when tested using a DSC thermogram with a first heat cycle starting at −85° C. and ramped at 10° C./min to 350° C., cooling to −85° C. at a rate of 10° C./min and a second heat cycle starting from −85° C. and ramped at 10° C./min to 350° C. Exemplary amorphous random fluorinated copolymers may include: copolymers comprising TFE and propylene monomeric units; copolymers comprising TFE, propylene, and VDF monomeric units; copolymers comprising VDF and HFP monomeric units; copolymers comprising TFE, VDF, and HFP monomeric units; copolymers comprising TFE and ethyl vinyl ether (EVE) monomeric units; copolymers comprising TFE and butyl vinyl ether (BVE) monomeric units; copolymers comprising TFE, EVE, and BVE monomeric units; copolymers comprising VDF and perfluorinated vinyl ethers monomeric units (such as copolymers comprising VDF and CF₂═CFOC₃F₇) monomeric units; copolymers comprising CTFE and VDF monomeric units; copolymers comprising TFE and VDF monomeric units; copolymers comprising TFE, VDF and perfluorinated vinyl ethers monomeric units (such as copolymers comprising TFE, VDF, and PMVE) monomeric units; copolymers comprising VDF, TFE, and propylene monomeric units; copolymers comprising TFE, VDF, PMVE, and ethylene monomeric units; copolymers comprising TFE, VDF, and perfluorinated vinyl ethers monomeric units (such as copolymers comprising TFE, VDF, and CF₂═CFO(CF₂)₃OCF₃) monomeric units; and combinations thereof.

In one embodiment, the partially fluorinated polymer is a block copolymer in which chemically different blocks or sequences are covalently bonded to each other, wherein the blocks have different chemical compositions and/or different glass transition temperatures. In one embodiment, the block copolymer comprises a first block, A block, which is a semi-crystalline segment. If studied under a differential scanning calorimetry (DSC), this block would have at least one melting point temperature (Tₘ) of greater than 70° C. and a measurable enthalpy, for example, greater than 0 J/g (Joules/gram). The second block, or B block, is an amorphous segment, meaning that there is an absence of long-range order (i.e., in long-range order the arrangement and orientation of the macromolecules beyond their nearest neighbors is understood). The amorphous segment has no detectable crystalline character by DSC. If studied under DSC, the B block would have no melting point or melt transitions with an enthalpy more than 2 milliJoules/g by DSC. In one embodiment, the A block is a copolymer derived from at least the following monomers: TFE, HFP, and VDF. In one embodiment, the A block comprises 30-85 wt (weight) % TFE; 5-40 wt % HFP; and 5-55 wt % VDF; 30-75 wt % TFE; 5-35 wt % HFP; and 5-50 wt % VDF; or even 40-70 wt % TFE; 10-30 wt % HFP; and 10-45 wt % VDF. In one embodiment, the B block is a copolymer derived from at least the following monomers: HFP and VDF. In one embodiment, the B block comprises 25-65 wt % VDF and 15-60 wt % HFP; or even 35-60 wt % VDF and 25-50 wt % HFP. Monomers, in addition, to those mentioned above, may be included in the A and/or B blocks. Generally, the weight average of the A block and B block are independently selected from at least 1000, 5000, 10000, or even 25000 daltons; and at most 400000, 600000, or even 800000 daltons. Such block copolymers are disclosed in WO 2017/013379 (Mitchell et al.); and U.S. Provisional Appl. Nos. 62/447,675, 62/447,636, and 62/447,664, each filed 18 Jan. 2017; all of which are incorporated herein by reference.

In one embodiment, the partially fluorinated polymer contains cure sites which facilitate cross-linking of the polymer in appropriate cure systems. These cure sites comprise at least one of iodine, bromine, and/or nitrile. The polymer may be polymerized in the presence of a chain transfer agent and/or cure site monomer to introduce cure sites into the polymer. Such cure site monomers and chain transfer agents are known in the art. Exemplary chain transfer agents include: an iodo-chain transfer agent, a bromo-chain transfer agent, or a chloro-chain transfer agent. For example, suitable iodo-chain transfer agent in the polymerization include the formula of RIₓ, where (i) R is a perfluoroalkyl or chloroperfluoroalkyl group having 3 to 12 carbon atoms; and (ii) x=1 or 2. The iodo-chain transfer agent may be a perfluorinated iodo-compound. Exemplary iodo-perfluoro-compounds include 1,3-diiodoperfluoropropane, 1,4-diiodoperfluorobutane, 1,6-diiodoperfluorohexane, 1,8-diiodoperfluorooctane, 1,10-diiodoperfluorodecane, 1,12-diiodoperfluorododecane, 2-iodo-1,2-dichloro-1,1,2-trifluoroethane, 4-iodo-1,2,4-trichloroperfluorobutan, and mixtures thereof. In some embodiments, the iodo-chain transfer agent is of the formula I(CF₂)ₙ—O—R_{f}—(CF₂)ₘI, wherein n is 1, 2, 3, 4, 5, 6, 7, 8, 9, or 10, m is 1, 2, 3, 4, 5, 6, 7, 8, 9, or 10 and R_{f} is a partially fluorinated or perfluorinated alkylene segment, which can be linear or branched and optionally comprises at least one catenated ether linkage. Exemplary compounds include: I—CF₂—CF₂—O—CF₂—CF₂—I, I—CF(CF₃)—CF₂—O—CF₂—CF₂—I, I—CF₂—CF₂—O—CF(CF₃)—CF₂—O—CF₂—CF₂—I, I—(CF(CF₃)—CF₂—O)₂—CF₂—CF₂—I, I—CF₂—CF₂—O—(CF₂)₂—O—CF₂—CF₂—I, I—CF₂—CF₂—O—(CF₂)₃—O—CF₂—CF₂—I, and I—CF₂—CF₂—O—(CF₂)₄—O—CF₂—CF₂—I, I—CF₂—CF₂—CF₂—O—CF₂—CF₂—I, and I—CF₂—CF₂—CF₂—O—CF(CF₃)—CF₂—O—CF₂—CF₂—I. In some embodiments, the bromine is derived from a brominated chain transfer agent of the formula: RBrₓ, where (i) R is a perfluoroalkyl or chloroperfluoroalkyl group having 3 to 12 carbon atoms; and (ii) x=1 or 2. The chain transfer agent may be a perfluorinated bromo-compound.

Cure site monomers, if used, comprise at least one of a bromine, iodine, and/or nitrile cure moiety.

In one embodiment, the cure site monomers may be of the formula: (a) CX₂═CX(Z), wherein: (i) X each is independently H or F; and (ii) Z is I, Br, R_{f}—U wherein U=I or Br and R_{f}=a perfluorinated or partially perfluorinated alkylene group optionally containing ether linkages or (b) Y(CF₂)_{q}Y, wherein: (i) Y is independently selected from Br or I or Cl and (ii) q=1-6. In addition, non-fluorinated bromo- or iodo-olefins, e.g., vinyl iodide and allyl iodide, can be used. Exemplary cure site monomers include: CH₂═CHI, CF₂═CHI, CF₂═CFI, CH₂═CHCH₂I, CF₂═CFCF₂I, ICF₂CF₂CF₂CF₂I, CH₂═CHCF₂CF₂I, CF₂═CFCH₂CH₂I, CF₂═CFCF₂CF₂I, CH₂═CH(CF₂)₆CH₂CH₂I, CF₂═CFOCF₂CF₂I, CF₂═CFOCF₂CF₂CF₂I, CF₂═CFOCF₂CF₂CH₂I, CF₂═CFCF₂OCH₂CH₂I, CF₂═CFO(CF₂)₃—OCF₂CF₂I, CH₂═CHBr, CF₂═CHBr, CF₂═CFBr, CH₂═CHCH₂Br, CF₂═CFCF₂Br, CH₂═CHCF₂CF₂Br, CF₂═CFOCF₂CF₂Br, CF₂═CFCl, I—CF₂—CF₂CF₂—O—CF═CF₂, I—CF₂—CF₂CF₂—O—CF₂CF═CF₂, I—CF₂—CF₂—O—CF₂—CF═CF₂, I—CF(CF₃)—CF₂—O—CF═CF₂, I—CF(CF₃)—CF₂—O—CF₂—CF═CF₂, I—CF₂—CF₂—O—CF(CF₃)—CF₂—O—CF═CF₂, I—CF₂—CF₂—O—CF(CF₃)—CF₂—O—CF₂—CF═CF₂, I—CF₂—CF₂—(O—(CF(CF₃)—CF₂)₂—O—CF═CF₂, I—CF₂—CF₂—(O—(CF(CF₃)—CF₂)₂—O—CF₂—CF═CF₂, Br—CF₂—CF₂—O—CF₂—CF═CF₂, Br—CF(CF₃)—CF₂—O—CF═CF₂, I—CF₂—CF₂—CF₂—O—CF(CF₃)—CF₂—O—CF═CF₂, I—CF₂—CF₂—CF₂—O—CF(CF₃)—CF₂—O—CF₂—CF═CF₂, I—CF₂—CF₂—CF₂—(O—(CF(CF₃)—CF₂)₂—O—CF═CF₂, I—CF₂—CF₂—CF₂—O—(CF(CF₃)—CF₂—O)₂—CF₂—CF═CF₂, Br—CF₂—CF₂—CF₂—O—CF═CF₂, Br—CF₂—CF₂—CF₂—O—CF₂—CF═CF₂, I—CF₂—CF₂—O—(CF₂)₂—O—CF═CF₂, I—CF₂—CF₂—O—(CF₂)₃—O—CF═CF₂, I—CF₂—CF₂—O—(CF₂)₄—O—CF═CF₂, I—CF₂—CF₂—O—(CF₂)₂—O—CF₂—CF═CF₂, I—CF₂—CF₂—O—(CF₂)₃—O—CF₂—CF═CF₂, I—CF₂—CF₂—O—(CF₂)₂—O—CF(CF₃)CF₂—O—CF₂═CF₂, I—CF₂—CF₂—O—(CF₂)₂—O—CF(CF₃)CF₂—O—CF₂—CF₂═CF₂, Br—CF₂—CF₂—O—(CF₂)₂—O—CF═CF₂, Br—CF₂—CF₂—O—(CF₂)₃—O—CF═CF₂, Br—CF₂—CF₂—O—(CF₂)₄—O—CF═CF₂, and Br—CF₂—CF₂—O—(CF₂)₂—O—CF₂—CF═CF₂. Examples of nitrile containing cure site monomers correspond to the following formulae: CF₂═CF—CF₂—O—R_{f}—CN; CF₂═CFO(CF₂)ᵣCN; CF₂═CFO[CF₂CF(CF₃)O]ₚ(CF₂)ᵥOCF(CF₃)CN; CF₂═CF[OCF₂CF(CF₃)]ₖO(CF₂)ᵤCN; wherein, r represents an integer of 2 to 12; p represents an integer of 0 to 4; k represents 1 or 2; v represents an integer of 0 to 6; u represents an integer of 1 to 6; and R_{f} is a perfluoroalkylene or a bivalent perfluoroether group. Specific examples of nitrile containing fluorinated monomers include, but are not limited to, perfluoro (8-cyano-5-methyl-3,6-dioxa-1-octene), CF₂═CFO(CF₂)₅CN, and CF₂═CFO(CF₂)₃OCF(CF₃)CN.

In one embodiment, the partially fluorinated polymer of the present disclosure comprises at least 0.1, 0.5, 1, 2, or even 2.5 wt % of iodine, bromine, and/or nitrile groups versus the total weight of partially fluorinated polymer. In one embodiment, the partially fluorinated polymer comprises no more than 3, 5, or even 10 wt % of iodine, bromine, and/or nitrile groups versus the total weight of the partially fluorinated polymer.

Protected Amino Silane

The compositions of the present disclosure comprise a compound that comprises a silane group and an amino group, wherein the amino group has latent functionality. These compounds are herein referred to as protected amino silanes. The protected amino silane compound comprises a nitrogen-containing functional group. This nitrogen-containing functional group upon exposure to an activating trigger (for example moisture, and/or heat) generates a primary or secondary amine. Such amino protecting groups disclosed herein include carbamates, and imines. Exemplary protected amino silanes include those characterized by the following general formulas:

(R³O)₃—Si-L-N═C(R¹)₂ (I); and

(R³O)₃—Si-L-NH—C(≡O)OR² (II)

wherein each R¹ is independently selected from a linear or branched alkyl group comprising 1 to 6 carbon atoms, R² is selected from H, and a linear or branched alkyl group comprising 1 to 4 carbon atoms, each R³ is independently an alkyl group comprising one or two carbon atoms, and L is a divalent aliphatic and/or aromatic hydrocarbon group.

Typically, the R³ groups of the protected amino silane are identical, but not always. Each R¹ is independently selected from a linear or branched alkyl group comprising 1 to 6 carbon atoms. Exemplary R¹ groups include —(CH₂)ₙCH₃ where n is an integer from 0 to 5; or —(CH₂)ₚCH(CH₃)₂ where p is an integer from 0 to 3. R² is selected from H, and a linear or branched alkyl group comprising 1 to 4 carbon atoms. Exemplary R² groups can include —C(CH₃)₃. L is a divalent hydrocarbon group comprising (i) an alkylene group having 1 to 4 carbon atoms, (ii) a divalent aromatic group having at least six carbon atoms, or (iii) combinations thereof. Such L groups can include methylene, ethylene, propylene, butylene, and divalent phenyl, benzyl, or naphtyl groups.

One example of a protected amino silane is N-(1,3-dimethylbutylidene)aminopropyl-triethoxysilane, depicted as follows:

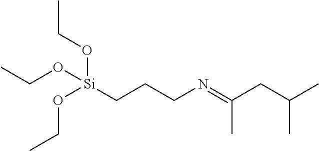 [SMILES: CCO[Si](CCC/N=C(\C)CC(C)C)(OCC)OCC]

Such compounds are available from Gelest, or from 3M under the trade designation “3M DYNAMER RUBBER CURATIVE RC5125”.

An example of another protected amino silane is N-(3-triethoxysilylpropyl)-O-t-butylcarbamate) depicted as follows:

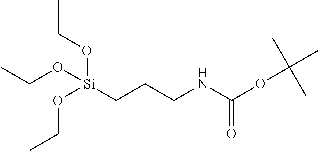 [SMILES: CCO[Si](CCCNC(=O)OC(C)(C)C)(OCC)OCC]

Such a compound is available from Gelest.

Although not wanting to be limited by theory, it is believed that following unmasking of the nitrogen-containing functional group, the group is converted to a primary amine —NH₂ or secondary amine —NH—that can then react, for example, with the partially fluorinated backbone of the fluoropolymer. In one embodiment, the protected nitrogen-containing functional group upon activation can liberate ketones or alkenes and carbon dioxide, resulting in deblocking the amine.

The protected amino silane can be homogeneously mixed with the fluoropolymer and due to the blocking of the amino group, the protected amino silane can remain unreacted until desired or has a delay in reaction, leading to longer pot life.

In one embodiment, the coating composition comprises at least 0.20, 0.25, 0.5, 1, 2, 3, or even 5 wt %; and at most 8 or even 10 wt % of the protected amino silane versus the weight of the coating composition.

Alkoxysilane

The composition of the present disclosure also comprises an alkoxysilane, which when used in combination with the protected amino silane, can result in good bonding of the partially fluorinated polymer to an inorganic substrate, especially in boiling water conditions.

Exemplary alkoxysilanes include tetraethylorthosilicate (TEOS), methyltrimethoxysilane, alkytrialkoxysilane, and oligomers thereof. Tetraalkoxysilanes, such as tetraethylorthosilicate (TEOS), and oligomeric forms oftetraalkoxysilane, such as alkyl polysilicates (e.g., poly(diethoxysiloxane)).

In one embodiment, the composition of the present disclosure comprises at least 0.1, 0.2, or even 0.3% by weight; and at most 0.4, 0.5, or even 1% by weight of the alkoxysilane.

Solvent

A solvent can be used to solubilize or disperse the partially fluorinated polymer so as to form a coating composition. Exemplary solvents include: alcohols (such as methanol or ethanol), ketones (such as methyl ethyl ketone), esters (such as ethyl acetate or butyl acetate), tetrahydrofuran, and combinations thereof. In one embodiment, the solvent has a molecular weight of less than 200, or even 100 grams/mole.

In one embodiment, the coating composition comprises at least 5, 10, 20, 25, or even 30% by weight of the solvent and at most 40, 50, 60 or even 70% by weight of the solvent.

Optional Additional Components

As can be seen in the Example Section, in one embodiment, the protected amino silane can be used to crosslink an amorphous polymer in the absence of a traditional crosslinking agent such as a peroxide, polyhydroxy compound, or multifunctional amine and organo-onium compounds.

In one embodiment, a peroxide curing agent may be used to facilitate curing of the partially fluorinated polymer and optionally, bonding to the substrate. In one embodiment, the peroxide is an organic peroxide, preferably, a tertiary butyl peroxide having a tertiary carbon atom attached to peroxy oxygen.

Exemplary peroxides include: benzoyl peroxide, dicumyl peroxide, di-tert-butyl peroxide, 2,5-di-methyl-2,5-di-tert-butylperoxyhexane, 2,4-dichlorobenzoyl peroxide, 1,1-bis(tert-butylperoxy)-3,3,5-trimethylchlorohexane, tert-butyl peroxy isopropylcarbonate (TBIC), tert-butyl peroxy 2-ethylhexyl carbonate (TBEC), tert-amyl peroxy 2-ethylhexyl carbonate, tert-hexylperoxy isopropyl carbonate, carbonoperoxoic acid, O,O′-1,3-propanediyl OO,OO′-bis(1,1-dimethylethyl) ester, tert-butylperoxy benzoate, t-hexyl peroxy-2-ethylhexanoate, t-butyl peroxy-2-ethylhexanoate, di(4-methylbenzoyl) peroxide, laurel peroxide and cyclohexanone peroxide. Other suitable peroxide curatives are listed in U.S. Pat. No. 5,225,504 (Tatsu et al.).

The amount of peroxide used generally will be at least 0.1, 0.2, 0.4, 0.6, 0.8, 1, 1.2, or even 1.5; at most 2, 2.25, 2.5, 2.75, 3, 3.5, 4, 4.5, 5, or even 5.5 parts by weight per 100 parts by weight of the partially fluorinated polymer.

Coagents are reactive additives used to improve the peroxide curing efficiency by rapidly reacting with radicals and potentially suppressing side reactions and/or generating additional crosslinks. The coagent forms a radical through hydrogen abstraction or addition of a radical from the peroxide, which can then react with the polymer through the Br, I, and/or nitrile sites. The coagents are multifunctional polyunsaturated compounds, which are known in the art and include allyl-containing cyanurates, isocyanurates, and phthalates, homopolymers of dienes, and co-polymers of dienes and vinyl aromatics. A wide variety of useful coagents are commercially available including di- and triallyl compounds, divinyl benzene, vinyl toluene, vinyl pyridine, 1,2-cis-polybutadiene and their derivatives. Exemplary coagents include a diallyl ether of glycerin, triallylphosphoric acid, diallyl adipate, diallylmelamine and triallyl isocyanurate (TAIC), tri(methyl)allyl isocyanurate (TMAIC), tri(methyl)allyl cyanurate, poly-triallyl isocyanurate (poly-TAIC), xylylene-bis(diallyl isocyanurate) (XBD), N,N′-m-phenylene bismaleimide, diallyl phthalate, tris(diallylamine)-s-triazine, triallyl phosphite, 1,2-polybutadiene, ethyleneglycol diacrylate, diethyleneglycol diacrylate, and combinations thereof. Exemplary partially fluorinated compounds comprising two terminal unsaturation sites include: CH₂═CH—R_{f1}—CH═CH₂ wherein R_{f1} may be a perfluoroalkylene of 1 to 8 carbon atoms and a fluorine-containing TAIC such as those disclosed in U.S. Pat. No. 6,191,233 (Kishine et al.).

In one embodiment, the composition comprises a peroxide and a coagent, wherein the amount of coagent used generally will be at least 0.1, 0.5, or even 1 part by weight per 100 parts by weight of the partially fluorinated polymer; and at most 2, 2.5, 3, or even 5 parts by weight per 100 parts by weight of the partially fluorinated polymer.

In another embodiment, an organo-onium may be used to facilitate curing of the partially fluorinated polymer and optionally, bonding to the substrate. Organo-onium compounds typically contain at least one heteroatom, i.e., a non-carbon atom such as N, P, S, O, bonded to organic or inorganic moieties and include for example ammonium salts, phosphonium salts and iminium salts. One class of useful quaternary organo-onium compounds broadly comprises relatively positive and relatively negative ions wherein a phosphorus, arsenic, antimony or nitrogen generally comprises the central atom of the positive ion, and the negative ion may be an organic or inorganic anion (e.g., halide, sulfate, acetate, phosphate, phosphonate, hydroxide, alkoxide, phenoxide, bisphenoxide, etc.). Many of the organo-onium compounds are described and known in the art. See, for example, U.S. Pat. No. 4,233,421 (Worm); U.S. Pat. No. 4,912,171 (Grootaert et al.); U.S. Pat. No. 5,086,123 (Guenthner et al.); U.S. Pat. No. 5,262,490 (Kolb et al.); and U.S. Pat. No. 5,929,169 (Jing et al.), herein incorporated by reference. Representative examples include the following individually listed compounds and mixtures thereof:

triphenylbenzyl phosphonium chloride

tributylallyl phosphonium chloride

tributylbenzyl ammonium chloride

tetrabutyl ammonium bromide

triaryl sulfonium chloride

8-benzyl-1,8-diazabicyclo[5,4,0]-7-undecenium chloride

benzyl tris(dimethylamino) phosphonium chloride,

tributyl methoxypropyl phosphonium chloride, and

benzyl(diethylamino)diphenylphosphonium chloride

Another class of useful organo-onium compounds include those having one or more pendent fluorinated alkyl groups. Generally, the most useful fluorinated onium compounds are disclosed in U.S. Pat. No. 5,591,804 (Coggio et al.), herein incorporated by reference.

In another embodiment, a polyhydroxy curing agent can be used to facilitate curing of the partially fluorinated polymer and optionally, bonding to the substrate.

Polyhydroxy compounds include those known in the art to function as a crosslinking agent or co-curative for elastomers, such as those polyhydroxy compounds disclosed in U.S. Pat. No. 3,876,654 (Pattison), and U.S. Pat. No. 4,233,421 (Worm), which are both herein incorporated by reference. Representative examples include aromatic polyhydroxy compounds, preferably any one of the following: di-, tri-, and tetrahydroxybenzenes, naphthalenes, and anthracenes, and bisphenols. Exemplary aromatic polyhydroxy compounds include: 4,4′-hexafluoroisopropylidenyl bisphenol, known more commonly as bisphenol AF. Further useful examples include 4,4′-dihydroxydiphenyl sulfone (also known as Bisphenol S) and 4,4′-isopropylidenyl bisphenol (also known as bisphenol A) or 4,4′(perfluoropropane-2,2-diyl)diphenol.

In another embodiment, crosslinking amines (multifunctional amines) can be used to facilitate curing of the partially fluorinated polymer and optionally, bonding to the substrate.

Exemplary crosslinking amines include: hexamethylenediamine and a carbamate thereof, 4,4′-bis(aminocyclohexyl)methane and a carbamate thereof, and N,N′-dicinnamylidene-1,6-hexamethylenediamine.

In another embodiment, a compound of the formula CX₁X₂═CX₃-L-M, can be used to facilitate curing of the partially fluorinated polymer and optionally, bonding to the substrate, wherein X₁, X₂, and X₃ are independently selected from H, Cl, and F and at least one of X₁, X₂, and X₃ is H and at least one is F or Cl, L is a single bond or linking group, and M is a nucleophilic group.

Exemplary curing agents of the formula CX₁X₂═CX₃-L-M have been disclosed in WO 2016/100421 (Grootaert et al.) and WO 2016/100420 (Grootaert et al.), incorporated by reference herein. For example, linking group, L, can be a catenated O, S, or N atom (e.g., an ether linkage), or a divalent organic group, optionally comprising a catenated heteroatom (e.g., O, S or N), and/or optionally substituted. Exemplary divalent organic groups include: —CH₂—C₆H₄(OCH₃)—, —CH₂—O—CH₂(CF₂)₄—CH₂— and —CH₂—O—C₆H₄—C(CF₃)₂—C₆H₄—, and —CH₂—O—C₆H₄—C(CF₃)₂—C₆H₄O—CH₂—. Exemplary nucleophilic group, M, includes: an alcohol (—OH), an amine (—NH₂, —NHR, and —NRR′ where R and R′ are an organic group), a thiol (—SH), and carboxylic acid (—COOH).

The above-mentioned curing agents may be present at less than 1 part (for example, more than 0.1 or even 0.5 parts) and at most 5 or even 10 parts by weight per 100 parts by weight of the partially fluorinated polymer.

For the purpose of, for example, enhancing the strength or imparting the functionality, conventional adjuvants, such as, for example, process aids (such as waxes, carnauba wax); plasticizers such as those available under the trade designation “STRUKTOL WB222” available from Struktol Co., Stow, Ohio; fillers; and/or colorants may be added to the composition.

Such fillers include: an organic or inorganic filler such as clay, alumina, iron red, talc, diatomaceous earth, barium sulfate, calcium carbonate (CaCO₃), calcium fluoride, titanium oxide, and iron oxide, a polytetrafluoroethylene powder, PFA (TFE/perfluorovinyl ether copolymer) powder, an electrically conductive filler, a heat-dissipating filler, and the like may be added as an optional component to the composition. Those skilled in the art are capable of selecting specific fillers at required amounts to achieve desired physical characteristics in the vulcanized compound.

In one embodiment, the composition of the present disclosure includes a silica nanoparticle. In one embodiment, the protected amino silane is disposed on the surface of the silica nanoparticle.

In one embodiment, the silica nanoparticles have an average diameter of the primary (individual) particle of at least 25 nm, 20 nm, 15 nm, 10 nm, 5 nm or even 3 nm; at most about 100 nm, 50 nm, 30 nm, 20 nm, or even 10 nm. The silica nanoparticles used in the polymerizable composition of the present disclosure are typically un-aggregated. If the silica nanoparticles are an aggregation of primary particles, then the maximum cross-sectional dimension of the aggregated nanoparticle is within the range of range of about 3 nm to about 100 nm, about 3 nm to about 50 nm, about 3 nm to about 20 nm, or even about 3 nm to about 10 nm.

The silica nanoparticles as used herein may be distinguished from materials such as fumed silica, pyrogenic silica, precipitated silica, etc. Such silica materials are known to those of skill in the art as being comprised of primary particles that are essentially irreversibly bonded together in the form of aggregates, in the absence of high-shear mixing. These silica materials have an average size greater than 100 nm (e.g., typically of at least 200 nanometers) and from which it is not possible to straightforwardly extract individual primary particles.

The silica nanoparticles may be in the form of a colloidal dispersion. Examples of useful commercially available unmodified silica nanoparticles include commercial colloidal silica sols available from Nalco Chemical Co. (Naperville, Ill.) under the trade designation “NALCO COLLOIDAL SILICAS” or Nissan Chemical America Corporation (Houston, Tex.) under the trade designation “SNOWTEX”. For example, such silicas include NALCO products 1040, 1042, 1050, 1060, 2327 and 2329.

In one embodiment, carbon black is added to the coating composition. Carbon black fillers are typically employed as a means to balance modulus, tensile strength, elongation, hardness, abrasion resistance, conductivity, and processability of polymer compositions. Suitable examples include MT blacks (medium thermal black) designated N-991, N-990, N-908, and N-907; FEF N-550; and large particle size furnace blacks. When used, 1 to 100 parts by weight of large size particle black filler per hundred parts by weight of the partially fluorinated polymer is generally sufficient.

In one embodiment, the composition comprises less than 40, 30, 20, 15, or even 10% by weight of the inorganic filler per hundred parts by weight of the partially fluorinated polymer.

Acid acceptors are typically used in elastomer curing as acid scavengers. Acid acceptors are typically used in elastomer cure reactions involving a dehydrohalogenation cure reaction. In one embodiment, the coating compositions disclosed herein are substantially free of an acid acceptor. In other words, the composition comprises less than 0.1, 0.05, or even 0.01 parts by weight of the acid acceptor per 100 parts by weight of the partially fluorinated polymer. In another embodiment, the coating composition can comprise a small amount of acid acceptor, such as more than 0.5, 1, or even 3 parts by weight and no more than 5, 10, 15 or even 20 parts by weight per 100 parts by weight of the partially fluorinated polymer.

Acid acceptors are typically inorganic bases such as metal oxide or metal hydroxide or a blend of the inorganic base and an organic acid acceptor. Examples of inorganic acceptors include magnesium oxide, lead oxide, calcium oxide, calcium hydroxide, dibasic lead phosphate, zinc oxide, barium carbonate, strontium hydroxide, calcium carbonate, hydrotalcite, etc. Organic acceptors include epoxies, alkali stearates (such as sodium stearate), tertiary amines, and magnesium oxalate. In one embodiment, the coating compositions of the present disclosure are substantially free of a metal oxide, meaning they comprise less than 1.0, 0.5, 0.1, or even 0.01% of a metal oxide.

The coating compositions may be prepared by mixing the partially fluorinated polymer, the protected amino silane, the alkoxy silane, solvent and the optional curing system and optional additives.

In one embodiment, the composition comprises at least 5, 10, 20, 25, or even 30% solids and at most 40, 50, 60 or even 70% solids based on weight. Generally, compositions having more solids are preferred.

The coating compositions of the present disclosure may be coated onto substrates, such as inorganic substrates. Exemplary inorganic substrates include, glass, ceramic, glass ceramic, or metals such as carbon steel (e.g., high-carbon steel, stainless steel, aluminized steel), stainless steel, aluminum, aluminum alloys, and combinations thereof.

In the present disclosure, the inorganic substrate may be smooth or roughened. In one embodiment, the inorganic substrate is treated before use. The inorganic substrate may be chemically treated (e.g., chemical cleaning, etching, etc.) or abrasively treated (e.g., grit blasting, microblasting, water jet blasting, shot peening, ablation, or milling) to clean or roughen the surface prior to use.

In one embodiment, the inorganic substrate's surface is treated with abrasive particles such that the substrate's surface becomes partially coated (for example less than 90, 80, 75, 50, or even 25%) with silicon dioxide. The silicon dioxide containing surface can be further modified, for example with silanes prior to the coating of the first fluoropolymer layer. Such treatment is described in U.S. Pat. No. 5,024,711 (Gasser et al.) and U.S. Pat. No. 5,185,184 (Koran et al.)). This pre-treatment method can provide a durable layer with strong adhesive strength.

Bonding agents and primers may be used to pretreat the surface of the substrate before coating. For example, bonding of the coating to metal surfaces may be improved by applying a bonding agent or primer. Examples include commercial primers or bonding agents, for example those commercially available under the trade designation CHEMLOK. In one embodiment, the articles of the present disclosure, do not comprise a primer between the substrate and the partially fluorinated polymer composition.

The substrate may be imbibed or coated with the coating solution using conventional techniques known in the art, including but not limited to, dip coating, roll coating, painting, spray coating, knife coating, gravure coating, extrusion, die-coating, and the like. The coating may be colored in cases where the compositions contains pigments, for example titanium dioxides or black fillers like graphite or soot, or it may be colorless in cases where pigments or black fillers are absent.

After coating, the solvent may be advantageously reduced or completely removed, for example by evaporation, drying or by boiling the solvent away from the sample. The coated sample can be heated at temperatures of room temperature or even higher, for example up to 100° C. or even 180° C. to remove solvent, depending on the solvent and the substrate used.

Typically, the coated sample is heated to bond the fluoropolymer composition to the substrate and optionally cure the partially fluorinated polymer. In one embodiment, the sample is heated at a temperature of at least 120, 140, or even 150° C.; and at most 200, 220, 250 or even 300° C., for a period of at least 2, 5, 10, 15, 30, or even 60 minutes; and at most 2, 5, 10, 15, 24, 36, or even 48 hours depending on the cross-sectional thickness of the sample. For thick sections of coating, the temperature during the heating step is usually raised gradually from the lower limit of the range to the desired maximum temperature. Generally, processing of the coated article is carried out by conveying the coated article through an oven with an increasing temperature profile from entrance to exit.

In one embodiment, the cured coating is at least 12 micrometers (0.5 mils), 15, 20, 25, 50, or even 100 micrometers thick; and at most 500, 1000, or even 2000 micrometers thick.

In one embodiment, the cured compositions of the present disclosure have adhesion to the substrate. For example, when rubbed with solvent the coating is not removed from the inorganic substrate in less than 5 cycles. In some embodiments, the coating is not removed or not easily removed from the inorganic substrate after being subjected to a boiling water emersion test. For example, after being immersed for 60 minutes in boiling water, the coating cannot peel off or the coating breaks upon peeling.

The addition of the protected amino silane results in a coating composition that remains in a liquid state until cure. This assists in extending the shelf life of the curable composition. For example, in one embodiment, the coating composition has a shelf life of at least 24, or even 64 hours.

The fluoropolymer coatings disclosed herein may be advantageously used for impregnating, printing on (for example by screen printing), or coating substrates comprising an elastomeric material.

### Examples

Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Mo., or may be synthesized by known methods. Table 1 (below) lists materials used in the examples and their sources.

TABLE 1
Materials List

| Designation | Description |
|---|---|
| Fluoropolymer | Iodo-containing fluorinated |
| | tetrafluoroethylene/hexafluoropropylene/vinylidene fluoride (TFE/HFP/VDF) |
| | terpolymer characterized by a Mooney viscosity |
| | (ML 1 + 10 @ 121° C.) of 45 and a fluorine content of 70% |
| TEOS | Tetraethyl orthosilicate from Sigma-Aldrich (St. Louis, MO, USA) |
| APS | (3-Aminopropyl)trimethoxy silane from Sigma-Aldrich |
| RC5125 | A solution of 3-(1,3-dimethylbutylidene)aminopropyltriethoxysilane) CAS No. |
| | 116229-43-7 available under the trade designation “3M DYNAMAR |
| | RUBBER CURATIVE RC5125” from 3M Co. Maplewood, MN, USA |
| Nanosilica | 9-14 nanometer (nm) silica particles (30 wt %) dispersed in isopropyl alcohol, |
| | Nissan Chemical America Corporation (Houston, TX) |
| MeOH | Methanol from Sigma-Aldrich |
| MEK | Methyl Ethyl Ketone from Sigma-Aldrich |
| CB | Carbon black, obtained under the trade designation “THERMAX N990”, from |
| | Cancarb, Medicine Hat, Alberta, Canada |
| TAIC | Triallyl isocyanurate from Nippon Kasei Chemical Co., Ltd., Tokyo, Japan |
| DBPH | 2,5-Bis(tert-butylperoxy)-2,5-dimethylhexane, 90% active from Sigma- |
| | Aldrich |
| RC5110 | 43% active pre-reacted complex of an organophosphonium salt accelerator and |
| | bisphenol AF crosslinking agent in alcohol; obtained under the trade |
| | designation “3M DYNAMAR RUBBER CURATIVES RC5110” from 3M Co. |
| RC5105 | 70% bisphenol AF crosslinking agent in ethanol; obtained under the trade |
| | designation “3M DYNAMAR RUBBER CURATIVES RC5105” from 3M Co. |

Boiling Water Emersion Test Method

The boiling water emersion test method is a quick and preliminary test. It was conducted to accelerate an interfacial adhesion water resistance and to understand if interfacial adhesion was covalently bonded to a substrate or was just polar-polar interactions with a substrate. Typically, coated samples were placed into a beaker of boiling water for approximately 1 to 2 hours continuously. Sample peel tests were conducted according to the Peel Test Method below on the sample before and after immersion in the boiling water.

Peel Test Method

Prepared fluoropolymer coating solutions were coated with a #18 Meyer bar on stainless steel (SS) substrate (SS may be treated by abrading with 3M 320 sand paper (Maplewood, Minn.) and subsequently rinsed with water and IPA). The resulting coatings were cured at 80-100° C. for 5 minutes and subsequently at 140-175° C. for 5-10 minutes. Initial peel strength was tested by cutting an edge of the fluoropolymer coating, and using the tester/operator's thumb to rub the cut edge with hard pressure toward the center of the coating. If the coating film could not be peeled off by thumb rubbing, the sample was subjected to the Boiling Water Emersion Test Method for 60 minutes. The sample was then immediately dried with a paper towel and the peel test was repeated as described previously. Results are classified according to the values listed in Table 2.

TABLE 2

| | |
|---|---|
| 1 | Coating peels off with moderate force |
| 3 | Coating peels off with greater force |
| 5 | Coating cannot peel off or breaks upon peeling |

Solvent Rub Resistant Test Method

A paper towel was dipped in MEK and allowed to saturate. The paper towel was then removed from the MEK and was used to wipe the fluoropolymer coating side of the sample in a back and forth manner at a moderate pressure. A cycle is counted as a backward and forward pass across the sample. Results are reported in cycles required for coating removal (i.e., when the coating is fully removed so that the substrate is visible).

Coating Layer Curing/Crosslinking Test Method

Fluoropolymer coating solutions were prepared as described below in a MEK-Methanol mixed solvent (30 wt % of fluoropolymer) and were separately sampled in aluminum foil dishes. The samples were quickly air-dried and subsequently cured at 150-175° C. for 5-10 minutes separately. The resulting cured coating films were peeled off and placed in MEK separately. The solutions were stirred overnight to determine if films were dissolved or not dissolved in the solvent. Films which were not soluble in the solvent were considered to be crosslinked.

Coating Solution Shelf Life Test

The prepared fluoropolymer coating solutions were allowed to sit at ambient conditions. Solution stability or shelf life was determined when a coating solution was gelled or not flowable. The corresponding time to reach a gelled or not flowable solution was recorded.

General Coating Procedure

The mixed fluoropolymer solutions were deposited via pipet at ambient conditions on a 304 stainless-steel (SS) substrate (SS may be treated by abrading with 3M 320 sand paper (Maplewood, Minn.) and subsequently rinsed with isopropyl alcohol before use). The coated samples, roughly 1 mil (25.4 micron) thick, were dried at 90° C. for 10 minutes and subsequently cured at 160° C. for 5 minutes.

### General Procedure for Comparative Examples to 4 (CE-1 to CE-4) and Examples 1 to 22 (EX-1 to EX-22)

Tables 3, 5, and 6 summarize the fluoropolymer coating solution formulations used in the following examples. Fluoropolymer containing N990 carbon black (CB) at 30 wt % (Fluoropolymer/CB, 30 grams (g)) was dissolved at 30 wt % in a mixed solvent of MEK (63 grams) and methanol (7 grams) by shaking at room temperature. A comparative example and an example were also prepared containing no carbon black, where 30 g of Fluoropolymer was dissolved at 30 wt % in a mixed solvent of MEK (63 grams) and methanol (7 grams) by shaking at room temperature (CE-2 and EX-1). APS, RC5125, and TEOS were separately dissolved in methanol in 10 wt % solutions before they were added to the Fluoropolymer/CB MEK/MeOH solution for coating in a ratio as described in Tables 3, 5, and 6 below. The solutions were well mixed for an hour before being coated on separate coupons according to the General Coating Procedure above.

Fluoropolymer coating solutions were also prepared by mixing the above Fluoropolymer/CB MEK/MeOH solution with APS or RC5125 attached to a silica nanoparticle dispersed in an alcohol (EX-5). The organic silane attached nanosilica solutions were prepared by diluting the 30 wt % nanosilica dispersion to a 10 wt % dispersion in isopropyl alcohol (IPA). The organic silane reagent was then prepared as a 10 wt % stock solution using the 10 wt % nanosilica dispersion in IPA as the solvent. The silane/nanosilica solution was then added to the fluoropolymer solution at a ratio according to Table 3. A tetraalkoxysilane, exemplified here by TEOS, was also included in the final mixture (see Table 3). The final fluoropolymer coating compositions were as described in Table 3 below. The solutions were well mixed for an hour before being coated on separate coupons according to the General Coating Procedure above.

Additionally, some examples (CE-3, CE-4 and EX-17 to EX-22) were prepared by mixing the above Fluoropolymer/CB MEK/MeOH solution with desired amounts of TAIC and DBPH were compounded together according to the ratios listed in Table 6, RC5110, RC5105, RC5125 and TEOS were then added (a stock solution of each was prepared at a 10 wt % solution in MeOH and added to the fluoropolymer solution) according to Table 6. The solutions were well mixed for an hour before being coated on separate abraded SS coupons according to the General Coating Procedure above, except the coatings were air-dried and cured at 175-200° C. for 5 minutes.

The cured fluoropolymer samples were subjected to the Peel Test Method and the MEK Rub Test Method (both described previously) after undergoing the Boiling Water Emersion Test Method (described above). The coatings were also subjected to MEK solvent immersion (Coating Layer Curing/Crosslinking Test Method, see above) to determine if the fluoropolymers were crosslinked. Additionally, coating solution shelf-life times were recorded for cured fluoropolymer samples. Results are described below and shown in Tables 4, and 7.

TABLE 3

| | Fluoropolymer Solution | RC5125* | Nanosilica | TEOS,** |
|---|---|---|---|---|
| Example | Fluoropolymer/CB, g | wt %^{†} | wt %^{†} | wt %^{†} |
| CE-1 | 1.5 | 0 | 0 | 0 |
| CE-2 | 1.5*** | 0 | 0 | 0 |
| EX-1 | 1.5*** | 2.0 | 0 | 1.5 |
| EX-2 | 1.5 | 1.5 | 0 | 1.5 |
| EX-3 | 1.5 | 2 | 0 | 1.5 |
| EX-4 | 1.5 | 3 | 0 | 1.5 |
| EX-5 | 1.5 | 3 | 3 | 1.5 |

*Stock solutions = separately prepared 10 wt % RC5125 in MeOH; or 10 wt % RC5125 prepared in a 10 wt % nanosilica dispersion in IPA.
**Stock solution = 10 wt % TEOS in MeOH.
^{†}Based on wt % of the fluoropolymer solution.
***Fluoropolymer only; no carbon black present.

TABLE 4

| | | Peel Strength on Abraded | | |
|---|---|---|---|---|
| | Peel Strength on | SS After 100° C. Water | Coating | Shelf |
| Exam- | Abraded SS (on | Immersion (on Not | Cross- | Lifetime, |
| ple | Not Abraded SS) | Abraded SS) | linked | hours |
| CE-1 | 1 (1) | 1 (1) | No | Liquid* |
| CE-2 | 1 (1) | 1 (1) | No | Liquid* |
| EX-1 | 5 | 5 | Yes | >24 |
| EX-2 | 5 (5) | 5 (3) | Yes | >64 |
| EX-3 | 5 (5) | 5 (3) | Yes | >64 |
| EX-4 | 5 (5) | 5 (5) | Yes | >64 |
| EX-5 | 5 (5) | 5 (5) | Yes | >72 |

*Remained a liquid after 24 hours.

TABLE 5

| | Fluoropolymer Solution | | | | |
|---|---|---|---|---|---|
| Exam- | Fluoropolymer/ | TAIC, wt %^{†}; | RC5125,* | APS,* | TEOS**, |
| ple | CB, g | DBPH, wt %^{†} | wt %^{†} | wt %^{†} | wt %^{†} |
| EX-6 | 10 | 0 | 0.75 | 1.5 | 1.5 |
| EX-7 | 5 | TAIC, 1.8 | 0.5 | 0.75 | 1.5 |
| | | DBPH, 1.0 | | | |
| EX-8 | 5 | TAIC, 1.8 | 0.5 | 1.0 | 1.5 |
| | | DBPH, 1.0 | | | |
| EX-9 | 5 | TAIC, 1.8 | 0.5 | 1.5 | 1.5 |
| | | DBPH, 1.0 | | | |
| EX-10 | 5 | TAIC, 1.8 | 0.5 | 2.0 | 1.5 |
| | | DBPH, 1.0 | | | |
| EX-11 | 5 | TAIC, 1.8 | 0.75 | 0.75 | 1.5 |
| | | DBPH, 1.0 | | | |
| EX-12 | 5 | TAIC, 1.8 | 0.75 | 1.0 | 1.5 |
| | | DBPH, 1.0 | | | |
| EX-13 | 5 | TAIC, 1.8 | 0.7 | 1.5 | 1.5 |
| | | DBPH, 1.0 | | | |
| EX-14 | 5 | TAIC, 1.8 | 0.75 | 2.0 | 1.5 |
| | | DBPH, 1.0 | | | |

*Stock solutions = separately prepared 10 wt % APS or RC5125 in MeOH.
**Stock solution = 10 wt % TEOS in MeOH.
^{†}Based on wt % of the fluoropolymer solution.

Example EX-6 through EX-14 all had “5” for Peel Strength on Abraded SS; “5” for Peel Strength on Abraded SS after 100° C. Water Immersion; all have the coating crosslinked and after 24 hours were still liquid.

TABLE 6

| | Fluoropolymer Solution | | | | | |
|---|---|---|---|---|---|---|
| | Fluoropolymer/ | TAIC, wt %^{†}; | RC5125,* | RC5110,* | RC5105,* | TEOS**, |
| Example | CB, g | DBPH, wt %^{†} | wt %^{†} | wt %^{†} | wt %^{†} | wt %^{†} |
| EX-15 | 5 | TAIC, 0.65 | 0.6 | 0 | 0 | 0.5 |
| | | DBPH, 0.22 | | | | |
| EX-16 | 5 | TAIC, 0.65 | 2.0 | 0 | 0 | 0.5 |
| | | DBPH, 0.22 | | | | |
| CE-3 | 5 | TAIC, 0.65 | 0.22 | 0.76 | 0.45 | 0 |
| | | DBPH, 0.22 | | | | |
| EX-17 | 5 | TAIC, 0.65 | 0.6 | 0 | 0.45 | 0.5 |
| | | DBPH, 0.22 | | | | |
| CE-4 | 5 | TAIC, 0.65 | 0.6 | 0.76 | 0.45 | 0 |
| | | DBPH, 0.22 | | | | |
| EX-18 | 5 | TAIC, 0.65 | 0.6 | 0.76 | 0.45 | 0.5 |
| | | DBPH, 0.22 | | | | |
| EX-19 | 5 | TAIC, 0.65 | 1.0 | 0.76 | 0.45 | 0.5 |
| | | DBPH, 0.22 | | | | |
| EX-20 | 5 | TAIC, 0.65 | 2.0 | 0.76 | 0.45 | 0.5 |
| | | DBPH, 0.22 | | | | |
| EX-21 | 5 | TAIC, 0.65 | 1.0 | 0.5 | 0 | 0.5 |
| | | DBPH, 0.22 | | | | |
| EX-22 | 5 | TAIC, 0.54 | 1.0 | 0.3 | 0 | 0.5 |
| | | DBPH, 0.30 | | | | |

*Stock solutions = separately prepared 10 wt % APS, RC5125, RC5110, or RC5105 in MeOH.
**Stock solution = 10 wt % TEOS in Me0H.
^{†}Based on wt % of the fluoropolymer solution.

TABLE 7

| | Peel Strength on | | MEK | Shelf |
|---|---|---|---|---|
| EXAM- | Abraded SS After 100° C. | Coating | Solvent | Lifetime, |
| PLE | Water Immersion | Crosslinked | Rub Test* | hours |
| EX-15 | 5 | Yes | >30 | >96 |
| EX-16 | 5 | Yes | >30 | >96 |
| CE-3 | 3 | Yes | 8 | NT |
| EX-17 | 5 | Yes | 8 | NT |
| CE-4 | 3 | Yes | 12 | NT |
| EX-18 | 5 | Yes | 25 | >48 |
| EX-19 | 5 | Yes | >30 | >24 |
| EX-20 | 5 | Yes | >30 | >24 |
| EX-21 | 5 | Yes | >30 | >24 |
| EX-22 | 5 | Yes | >30 | NT |

*Results reported in cycles required for coating removal.
NT means not tested.

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. A coating composition comprising
(a) a partially fluorinated polymer, wherein the partially fluorinated polymer comprises a C—F bond adjacent to a methylene unit or a hydrohalogenated methylene unit along the polymer backbone;
(b) a protected amino silane;
(c) an alkoxysilane; and
(d) a non-fluorinated solvent.

2. The coating composition of claim 1, wherein the protected amino silane comprises at least one of:
(R³O)₃—Si-L-N═C(R¹)₂ (I); and
(R³O)₃—Si-L-NH—C(≡O)OR² (II)
wherein each R¹ is independently selected from a linear or branched alkyl group comprising 1 to 6 carbon atoms, R² is selected from H, a linear alkyl group comprising 1 to 4 carbon atoms, or a branched alkyl group comprising 1 to 4 carbon atoms, each R³ is independently selected from an alkyl group comprising one or two carbon atoms, and L is a divalent aliphatic, an aromatic hydrocarbon group, or a combination thereof.

3. The coating composition of claim 1, wherein the protected amino silane comprises at least one of: N-(1,3-dimethylbutylidene)aminopropyl-triethoxysilane, and N-(3-triethoxysilylpropyl)-O-t-butylcarbamate).

4. The coating composition of claim 1, wherein the coating composition comprises at least 0.20% by weight of the protected amino silane.

5. The coating composition of claim 1, wherein the partially fluorinated polymer comprises at least one of: (i) a copolymer comprising tetrafluoroethylene, vinylidene fluoride, and hexafluoropropylene monomeric units; (ii) a copolymer comprising tetrafluoroethylene, and propylene monomeric units; (iii) a copolymer comprising tetrafluoroethylene, vinylidene fluoride, and propylene monomeric units; and (iv) a copolymer comprising vinylidene fluoride, perfluoro (methyl vinyl) ether, and hexafluoropropylene monomeric units; (v) a copolymer comprising tetrafluoroethylene, vinyl fluoride, and hexafluoropropylene monomeric units; and (vi) a copolymer comprising vinyl fluoride, perfluoro (methyl vinyl) ether, and hexafluoropropylene monomeric units.

6. The coating composition of claim 1, wherein the partially fluorinated polymer is a block copolymer comprising at least one A block and at least one B block, optionally, wherein the A block comprises 30-85 wt % tetrafluoroethylene; 5-40 wt % hexafluoropropylene; and 5-55 wt % vinylidene fluoride; and the B block comprises 25-65 wt % vinylidene fluoride and 15-60 wt % hexafluoropropylene based on the weight of the partially fluorinated polymer.

7. The coating composition of claim 1, wherein the partially fluorinated polymer comprises at least 0.1% by weight of a cure site, wherein the cure sites comprise at least one of bromine and iodine.

8. The coating composition of claim 1, wherein the composition further comprises a peroxide, optionally, wherein the peroxide comprises at least one of 2,5-dimethyl-2,5-di(t-butylperoxy)hexane; dicumyl peroxide; di(2-t-butylperoxyisopropyl)benzene; dialkyl peroxide; bis (dialkyl peroxide); 2,5-dimethyl-2,5-di(tertiarybutylperoxy)₃-hexyne; dibenzoyl peroxide; 2,4-dichlorobenzoyl peroxide; tertiarybutyl perbenzoate; α,α′-bis(t-butylperoxy-diisopropylbenzene); t-butyl peroxy isopropylcarbonate, t-butyl peroxy 2-ethylhexyl carbonate, t-amyl peroxy 2-ethylhexyl carbonate, t-hexylperoxy isopropyl carbonate, di[1,3-dimethyl-3-(t-butylperoxy)butyl]carbonate, carbonoperoxoic acid, and O,O′-1,3-propanediyl OO,OO′-bis(1,1-dimethylethyl) ester.

9. The coating composition of claim 8, further comprising a coagent, optionally, wherein the coagent comprises at least one of (i) diallyl ether of glycerin, (ii) triallylphosphoric acid, (iii) diallyl adipate, (iv) diallylmelamine and triallyl isocyanurate, (v) tri(methyl)allyl isocyanurate, (vi) tri(methyl)allyl cyanurate, (vii) poly-triallyl isocyanurate, (viii) xylylene-bis(diallyl isocyanurate), and (xi) CH2═CH-Rf1-CH═CH2 wherein R_{f}1 is a perfluoroalkylene of 1 to 8 carbon atoms.

10. The coating composition of claim 1, wherein the composition is substantially free of a metal oxide.

11. The coating composition of claim 1, wherein the composition comprises an organo-onium, and optionally, wherein the organo-onium is one of an ammonium salt, a sulfonium, a phosphonium salt or an iminium salt.

12. The coating composition of claim 1, further comprising a polyhydroxy curing agent, optionally, wherein the polyhydroxy curing agent is 4,4′(perfluoropropane-2,2-diyl)diphenol.

13. The coating composition of claim 1, wherein the alkoxysilane comprises at least one of tetraethylorthosilicate, methyltrimethoxysilane, alkytrialkoxysilane, alkenysilane including vinyl trialkoxysilane and oligomers thereof.

14. The coating composition of claim 1, wherein the coating composition comprises at least 0.1% by weight of the alkoxysilane.

15. (canceled)

16. The coating composition of claim 1, wherein the coating composition further comprises a silica nanoparticle and optionally, wherein the protected amino silane is disposed on the silica nanoparticle.

17. A method of making a coated article, the method comprising: coating a substrate with the coating composition according to claim 1.

18. The method of claim 17, wherein the substrate comprises at least one of glass, ceramic, and metal, wherein the metal is optionally selected from stainless steel, carbon steel, or aluminum.

19. The method of claim 17, further comprising heat treatment of the coated article.

20. An article comprising an inorganic substrate and a fluoropolymer composition bonded thereto, the fluoropolymer composition comprising (a) a partially fluorinated polymer, wherein the fluorinated polymer comprises a C—F bond adjacent to a methylene unit or a hydrohalogenated methylene unit along the polymer backbone;
(b) a protected amino silane;
(c) an alkoxysilane; and
(d) a non-fluorinated solvent.

21. The article of claim 20, wherein the fluoropolymer composition has a thickness of at least 12 micrometers.
